(19) United States
(12) Patent Application Publication
(10) Pub. No.: US 2006/0152939 A1
(43) Pub. Date: Jul. 13, 2006

(54) Illuminating device capable of being a vehicle headlight and a flashlight

(76) Inventor: Jung-Pei Huang, Kaohsiung City (TW)

Correspondence Address: Jung-Pei HUANG, P.O. BOX 90, Tainan City, 70499, TW

(21) Appl. No.: 11/166,137

(22) Filed: Jun. 27, 2005

(30) Foreign Application Priority Data
Jan. 12, 2005 (TW) 094100788

(51) Int. Cl. F21V 1/00

(52) U.S. Cl. 362/509

(57) ABSTRACT

An illuminating device capable of being a vehicle headlight and a flashlight comprises a lamp unit, a handle unit and a lamp mount. The lamp unit and the handle unit can be jointed to form a flashlight that will be held by a hand to provide illumination. Alternatively, the lamp unit and the lamp mount can be jointed to form a vehicle headlight after being mounted on a vehicle body.

### BACKGROUND OF THE INVENTION

1. Field of the Invention

The present invention relates to illuminating devices, particularly to an illuminating device comprising a lamp unit, a handle unit and a lamp mount, capable of being a vehicle headlight and a flashlight. Thereby, the lamp unit and the handle unit can be jointed to form a flashlight, and, alternatively, the lamp unit and the lamp mount can be jointed to form a vehicle headlight.

2. Description of the Prior Art

Illuminating devices of the prior art can be categorized into a portable type and a stationary type. The illuminating devices of the portable type are mainly flashlights. A vehicle headlight belongs to the stationary type. One has to buy both to satisfy the respective purposes. It will be beneficial for the consumers if an illuminating device capable of being a vehicle headlight and a flashlight is available.

### SUMMARY OF THE INVENTION

The primary objective of the present invention is to provide an illuminating device capable of being a vehicle headlight and a flashlight.

To achieve above object, the present invention provides an illuminating device capable of being a vehicle headlight and a flashlight comprises a lamp unit, a handle unit and a lamp mount. The lamp unit and the handle unit can be jointed to form a flashlight that will be held by a hand to provide illumination. Alternatively, the lamp unit and the lamp mount can be jointed to form a vehicle headlight after being mounted on a vehicle body.

The various objects and advantages of the present invention will be more readily understood from the following detailed description when read in conjunction with the appended drawings.

### BRIEF DESCRIPTION OF DRAWINGS

FIG. 1 is a perspective view of an illuminating device capable of being a vehicle headlight and a flashlight according to the present invention.

FIG. 2 shows components in FIG. 1 for assembling a flashlight.

FIG. 3 shows the combination of the lamp unit and the handle unit in FIG. 2 before the connection is secured.

FIG. 4 is a front cross-sectional view of the illuminating device in FIG. 3 before the connection is secured.

FIG. 5 is a front cross-sectional view of the illuminating device in FIG. 3 after the connection is secured.

FIG. 6 is a perspective view of a flashlight formed by the lamp unit and the handle unit in FIG. 2 after the connection is secured.

FIG. 7 shows components in FIG. 1 for assembling a vehicle headlight.

FIG. 8 is a perspective view of a vehicle headlight formed by the lamp unit and the lamp mount in FIG. 7.

FIG. 9 is a front cross-sectional view of the illuminating device in FIG. 8 before the connection is secured.

FIG. 10 is a front cross-sectional view of the illuminating device in FIG. 8 after the connection is secured.

### DETAILED DESCRIPTION OF THE PREFERRED EMBODIMENT

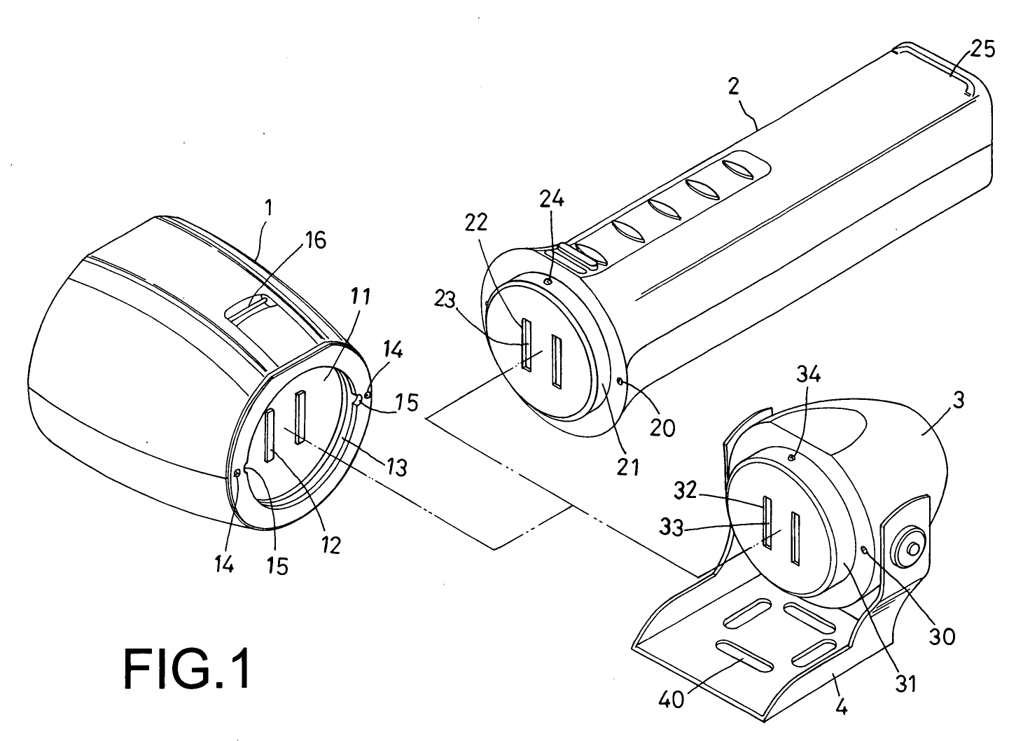

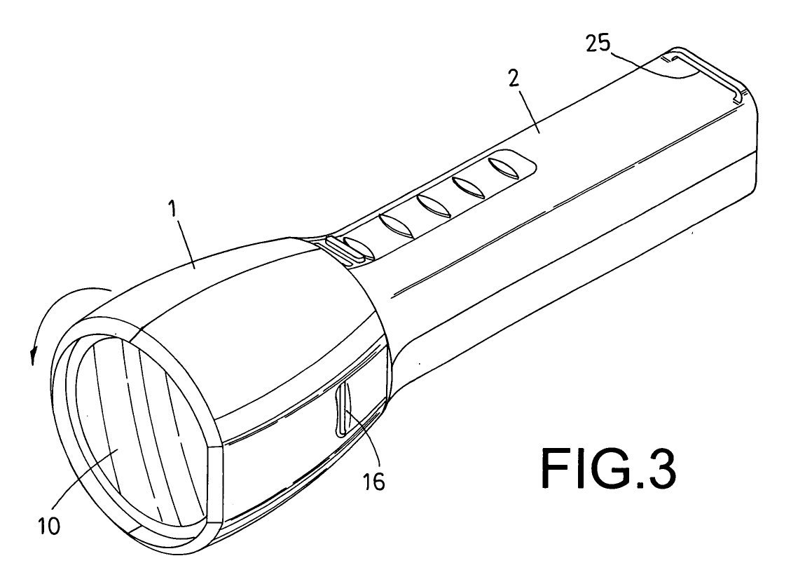

Referring to FIGS. 1, 2 and 3, an illuminating device capable of being a vehicle headlight and a flashlight according to the present invention comprises a lamp unit 1, a handle unit 2 and a lamp mount 3. The lamp unit 1 further comprises a transparent front cover 10 for protecting the light bulb housed therein. The rear end of the lamp unit 1 is provided with a recess 11, which further includes a pair of first conducting plates 12 located on an inner wall of the recess 11. An annular groove 13 is formed around the inner rim of the recess 11, and a pair of first teeth 14 is formed on the rear wall of the lamp unit 1 around the recess 11. Two breaches 15 are formed on the rear wall, 180 degrees apart and deep down to the annular groove 13. Further, the lateral wall of the lamp unit 1 is provided with a first hanger slot 16. The handle unit 2 can be connected to the rear end of the lamp unit 1. The front wall of the handle unit 2 is provided with a pair of first indentations 20 and a first projected head 21. The first projected head 21 further includes a pair of first slots 22, each containing one of a pair of second conducting plates 23. The lateral wall of the projected head 21 is provided with a pair of second teeth 24. Further, the rear end of the handle unit 2 is provided with a second hanger slot 25. The lamp mount 3 can be connected to the rear end of the lamp unit 1. The front wall of the lamp mount 3 is provided with a pair of second indentations 30 and a second projected head 31. The second projected head 31 further includes a pair of second slots 32, each containing one of a pair of third conducting plates 33. The lateral wall of the second projected head 31 is provided with a pair of third teeth 34. The bottom side of the lamp mount 3 is attached with a bracket 4, which bracket 4 is provided with a plurality of through holes 40 for retaining itself on a vehicle body.

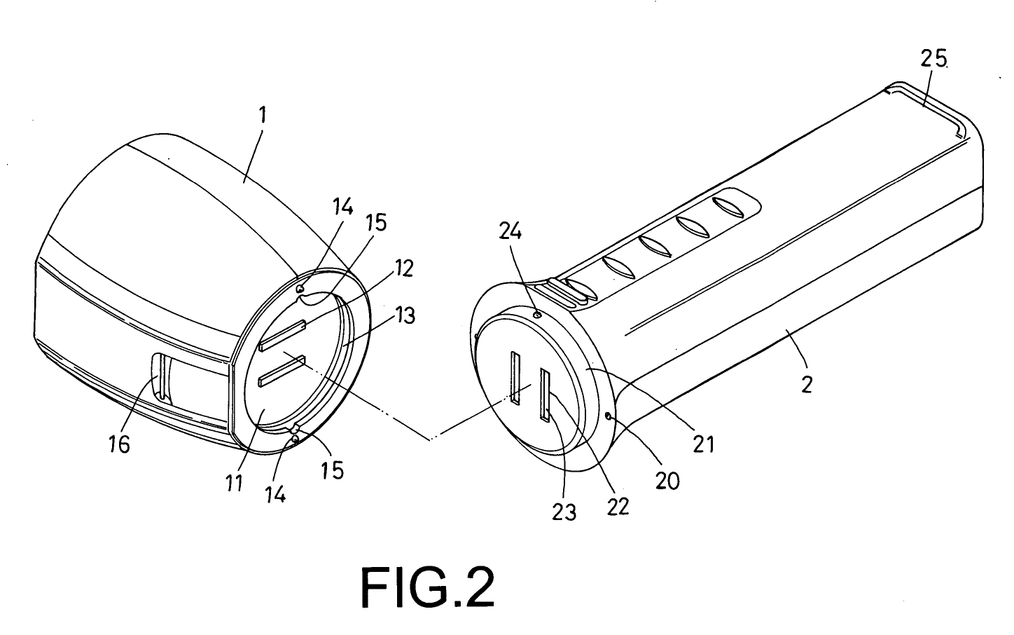

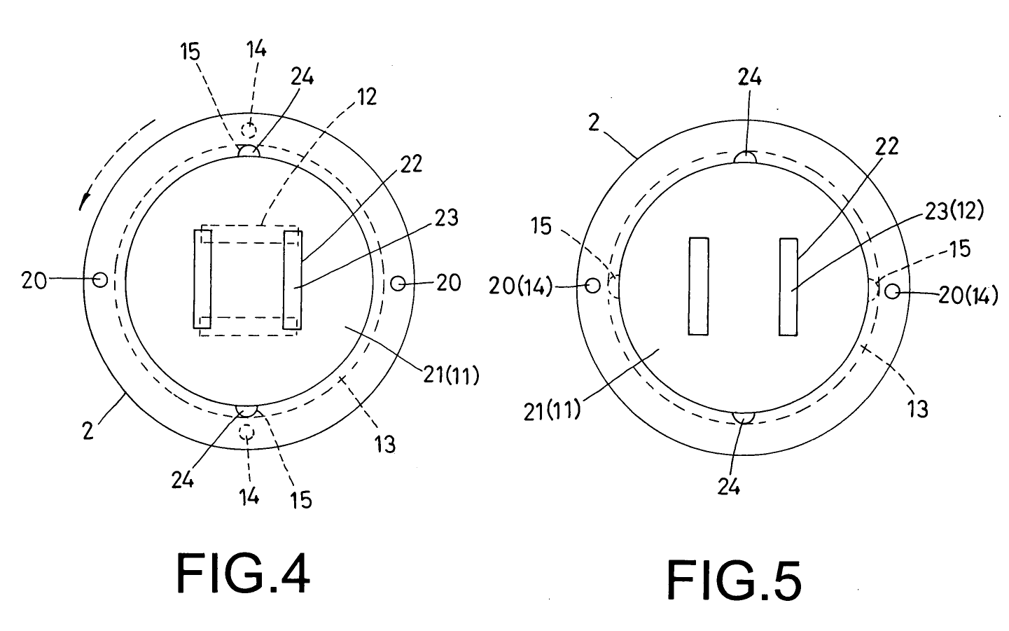

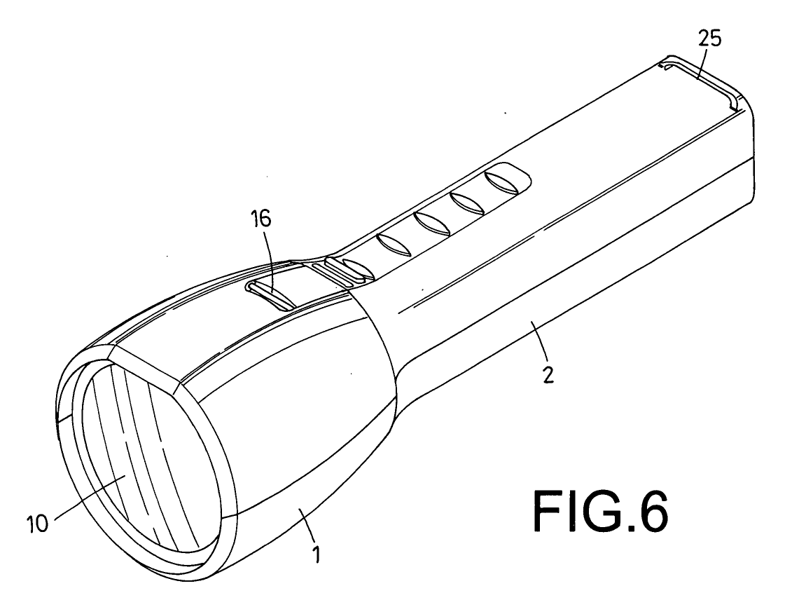

Refer to FIGS. 2, 3, 4, 5 and 6 for the use of the illuminating device as a flashlight. The front end of the handle unit 2 is inserted into the rear end of the lamp unit 1, namely, the first projected head 21 of the handle unit 2 being inserted into the recess 11 of the lamp unit 1. Thereby, the second teeth 24 on the projected head 21 of the handle unit 2 are engaged with the breaches 15 of the lamp unit 1 and reach within the annular groove 13. A relative rotation between the lamp unit 1 and the handle unit 2 is urged for 90 degrees, as shown in FIGS. 4 and 5, whereby the second teeth 24 of the handle unit 2 will be sliding along the annular groove 13, and whereby the second teeth 24 are away from the breaches 15. Therefore, the connection between the lamp unit 1 and the handle unit 2 are secured. Meanwhile, the first teeth 14 of the lamp unit 1 situate in the first indentations 20 of the handle unit 2, further retaining the lamp unit 1 and the handle unit 2. Further, the first conducting plates 12 within the recess 11 are coupled with the first slots 22 of the handle unit 2, whereby two sets of conducting plates 12 and 23 are held in an electric contact. Since the handle unit 2 can be held by a hand, the combined structure is a flashlight. Since the lamp unit 1 and the handle unit 2 are respectively provided with hanger slots 16 and 25, a strap can go through these hanger slots 16 or 25 to form a suspending belt. To dissemble the flashlight, a backward rotation between the lamp unit 1 and the handle unit 2 is applied for 90 degrees, whereby the second teeth 24 are again aligned with the breaches 15, and the lamp unit 1 and the handle unit 2 can be pulled apart.

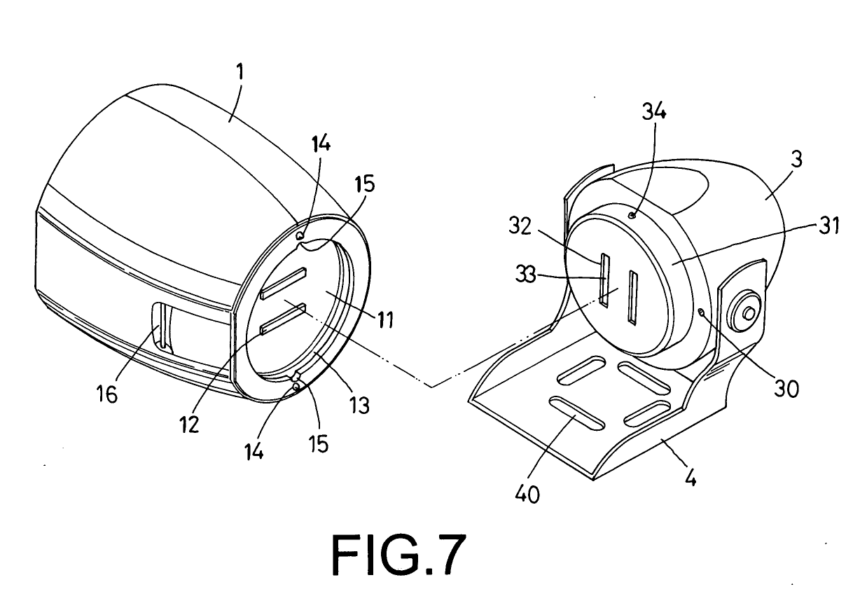

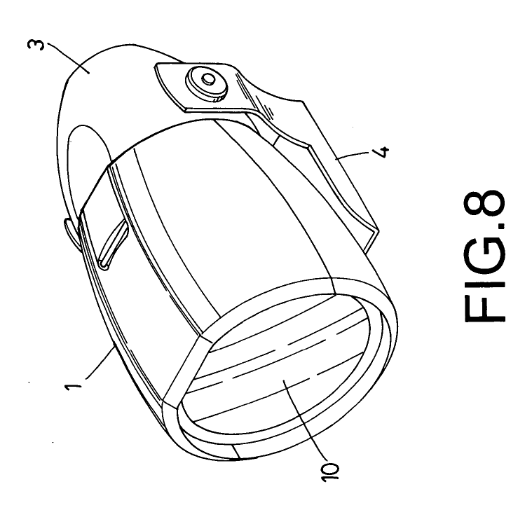

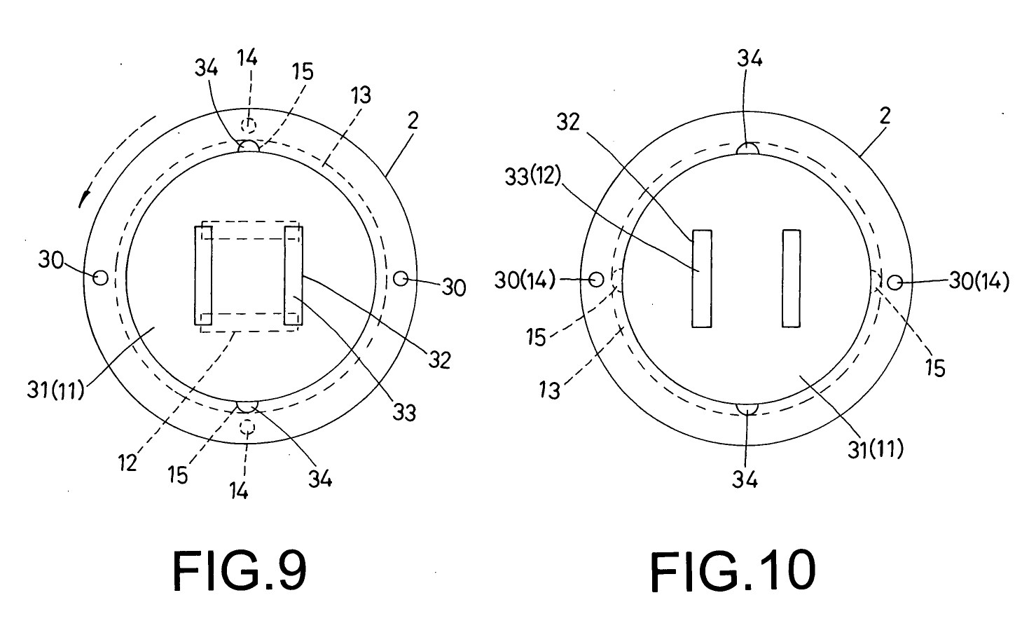

Refer to FIGS. 7, 8, 9 and 10 for the use of the illuminating device as a vehicle headlight. The front end of the lamp mount 3 is inserted into the rear end of the lamp unit 1, namely, the second projected head 31 of the lamp mount 3 being inserted into the recess 11 of the lamp unit 1. Thereby, the third teeth 34 on the second projected head 31 of the lamp mount 3 are engaged with the breaches 15 of the lamp unit 1 and reach within the annular groove 13. A relative rotation between the lamp unit 1 and the lamp mount 3 is urged for 90 degrees, as shown in FIGS. 9 and 10, whereby the third teeth 34 of the lamp mount 3 will be sliding along the annular groove 13, and whereby the third teeth 34 are away from the breaches 15. Therefore, the connection between the lamp unit 1 and the lamp mount 3 are secured. Meanwhile, the first teeth 14 of the lamp unit 1 situate in the second indentations 30 of the lamp mount 3, further retaining the lamp unit 1 and the lamp mount 3. Further, the first conducting plates 12 within the recess 11 are coupled with the second slots 32 of the lamp mount 3, whereby two sets of conducting plates 12 and 33 are held in an electric contact. Since the lamp mount 3 can be held by a hand, the combined structure is a flashlight. To dissemble the flashlight, a backward rotation between the lamp unit 1 and the lamp mount 3 is applied for 90 degrees, whereby the third teeth 34 are again aligned with the breaches 15, and the lamp unit 1 and the lamp mount 3 can be pulled apart.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An illuminating device capable of being a vehicle headlight and a flashlight, comprising:
a lamp unit provided with a transparent front cover and a recess formed at a rear wall thereof; said recess further including a pair of first conducting plates located on an inner wall thereof and an annular groove formed around an inner rim thereof, a pair of first teeth being formed on said rear wall of said lamp unit around said recess, a pair of breaches being formed on said rear wall, 180 degrees apart and with a depth connecting said annular groove;
a handle unit capable of being attached to said rear wall of said lamp unit, a front wall of said handle unit being provided with a pair of first indentations and a first projected head, said first projected head further including a pair of first slots each containing one of a pair of second conducting plates, a lateral wall of said projected head being provided with a pair of second teeth, whereby said handle unit can be connected with said lamp unit; and
a lamp mount provided with a pair of second indentations and a second projected head on a front wall thereof, said second projected head further including a pair of second slots each containing one of a pair of third conducting plates, a lateral wall of said second projected head being provided with a pair of third teeth, a bottom side of said lamp mount being attached with a bracket having a plurality of retaining through holes, whereby said lamp mount can be connected with said lamp unit.

2. The illuminating device capable of being a vehicle headlight and a flashlight of claim 1 wherein said lamp unit is further provided with a hanger slot.

3. The illuminating device capable of being a vehicle headlight and a flashlight of claim 1 wherein a rear end of said handle unit is further provided with a hanger slot.
